(19) United States
(12) Patent Application Publication
(10) Pub. No.: US 2024/0362422 A1
(43) Pub. Date: Oct. 31, 2024

(54) REVISING LARGE LANGUAGE MODEL PROMPTS

(71) Applicant: Microsoft Technology Licensing, LLC, Redmond, WA (US)

(72) Inventors: Shawn Cantin CALLEGARI, Bellevue, WA (US); Umesh MADAN, Bellevue, WA (US); Samuel Edward SCHILLACE, Portola Valley, CA (US); John MAEDA, Redmond, WA (US); LeRoy Ford MILLER, Tacoma, WA (US); Timothy Alan LAVERTY, Seattle, WA (US); Devis LUCATO, Kirkland, WA (US)

(73) Assignee: Microsoft Technology Licensing, LLC, Redmond, WA (US)

(21) Appl. No.: 18/322,524

(22) Filed: May 23, 2023

Related U.S. Application Data
(60) Provisional application No. 63/499,045, filed on Apr. 28, 2023.

(51) Int. Cl. G06F 40/40; G06F 9/54

(52) U.S. Cl. CPC G06F 40/40; G06F 9/543

(57) ABSTRACT

A computing system for revising large language model (LLM) input prompts is provided herein. In one example, the computing system includes at least one processor configured to receive, via a prompt interface, a prompt from a user including an instruction for a trained LLM to generate an output, and generate a first response to the prompt. The at least one processor is configured to assess the first response according to assessment criteria to generate an assessment report for the first response, and generate a revised prompt in response to second input including the first prompt, the first response, the assessment report, and a prompt revision instruction for the LLM to revise the prompt in view of the assessment report. The at least one processor is configured to, in response to final input including the revised prompt, generate a final response to the revised prompt, and output the final response.

### CROSS REFERENCE TO RELATED APPLICATIONS

This application claims priority to U.S. Provisional Patent App. No. 63/499,045, filed Apr. 28, 2023, the entirety of which is hereby incorporated herein by reference for all purposes.

### BACKGROUND

Recently, large language models (LLMs) have been developed that generate natural language responses in response to prompts entered by users. Many recent LLMS have been based on the transformer architecture, which utilizes tokenization and word embeddings to represent words in an input sequence, and a self-attention mechanism that is applied to allow each token to potentially attend to each other token in the input sequence during the training of the neural network. Examples of such LLMs include generative pre-trained transformers (GPTs) such as GPT-3, GPT-4, and GPT-J, as well as BLOOM, LLAMA, and others. Typically, these LLMs are sequence transduction transformer models that are trained on a next word prediction task. These types of LLMs are generative language models that repeatedly make next word predictions to generate an output sequence for a given input sequence. Such models are trained on natural language corpora including billions of words and have parameter sizes in excess of one billion parameters. These parameters are weights in the trained neural network of the transformer. Some of these models are fine-tuned using human reinforced learning or one-shot or few-shot learning based on ground truth examples. As a result of their large parameter size and in some cases their fine tuning, these LLMs have achieved superior results in generative tasks, such as generating responses to user prompts in a series of chat-style messages that substantively respond to an instruction in the prompt, in a particular writing style or format specified by the prompt, to a particular audience, and/or from a particular author's point of view.

One drawback with such models is that the usefulness of the response is greatly influenced by the quality of the prompt. Both novice users and experts alike experience the technical challenge of crafting the right prompt in order for the LLM to respond with the level of detail, precision, viewpoint, reasoning, etc., that the user desires. Sometimes users become frustrated with the LLM when it outputs inappropriate or useless responses missing the mark in response to overgeneralized prompts. As a result, the adoption of generative LLMs is not as widespread as it could be were this technical challenge overcome.

### SUMMARY

A computing system for revising large language model (LLM) input prompts is provided herein. In one example, the computing system includes at least one processor configured to cause a prompt interface for a trained LLM to be presented, and receive, via the prompt interface, a prompt from a user including an instruction for the LLM to generate an output. In this example, the at least one processor is configured to provide first input including the prompt to the LLM, and generate, in response to the first input, a first response to the prompt via the LLM. The at least one processor is configured to perform assessment and revision of the prompt, at least in part by assessing the first response according to assessment criteria to generate an assessment report for the first response, via the LLM, providing second input including the first prompt, the first response, the assessment report, and a prompt revision instruction to revise the prompt in view of the assessment report to the LLM, and generating a revised prompt in response to the second input, via the LLM. The at least one processor is configured to provide final input including the revised prompt to the LLM; in response to the final input, generate a final response to the revised prompt, via the LLM; and output the final response to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a schematic view showing a computing system for revising large language model (LLM) input prompts using a semantic function pipeline with assessment and revision executed by an LLM program for assessing responses of the LLM and revising prompts for the LLM, according to a first example implementation.

FIG. 1B is a schematic view showing a computing system for revising LLM input prompts, according to a second example implementation including a server computing device and a client computing device.

FIG. 1C is a schematic view showing a computing system for revising LLM input prompts, according to a third example implementation, in which two LLMs are used to revise and respond to the input prompts.

FIG. 2 is a schematic view showing an expanded version of the semantic function pipeline with assessment and revision implemented by the LLM program of the computing system of FIGS. 1A-C.

FIG. 3 shows a detailed view of a first part of the assessment and revision shown in FIG. 2.

FIG. 4 is a continuation of FIG. 3 and shows a detailed view of a second part of the assessment and revision.

FIG. 5 is a continuation of FIG. 4 and shows a third part of the assessment and revision of FIGS. 3 and 4.

FIG. 6 shows an example graphical user interface of the computing system of FIGS. 1A-C, illustrating background response assessment and prompt revision.

FIG. 7 shows another example graphical user interface of the computing system of FIGS. 1A-C, illustrating response assessment and prompt revision in response to user input.

FIG. 8 shows a flowchart for a method for revising LLM input prompts, according to one example implementation.

FIG. 9 shows a schematic view of an example computing environment in which the computing system of FIGS. 1A-C may be enacted.

### DETAILED DESCRIPTION

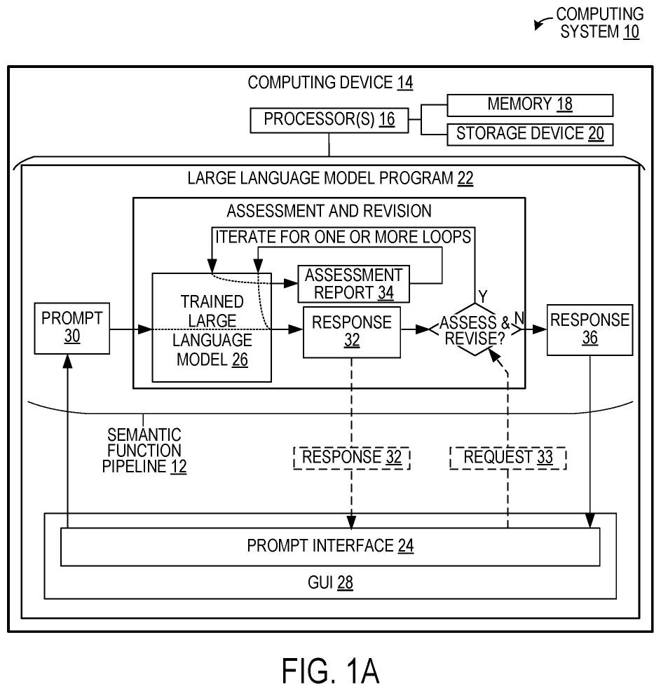

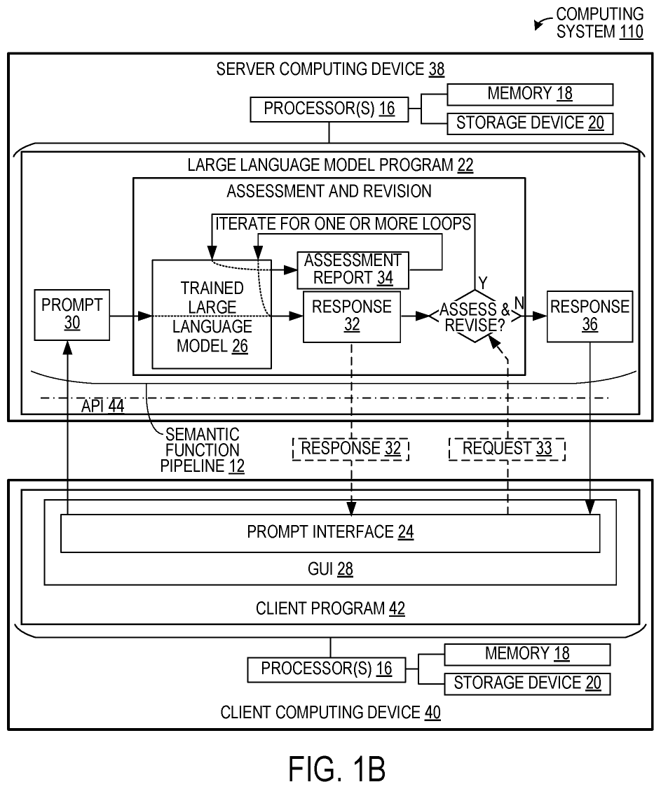

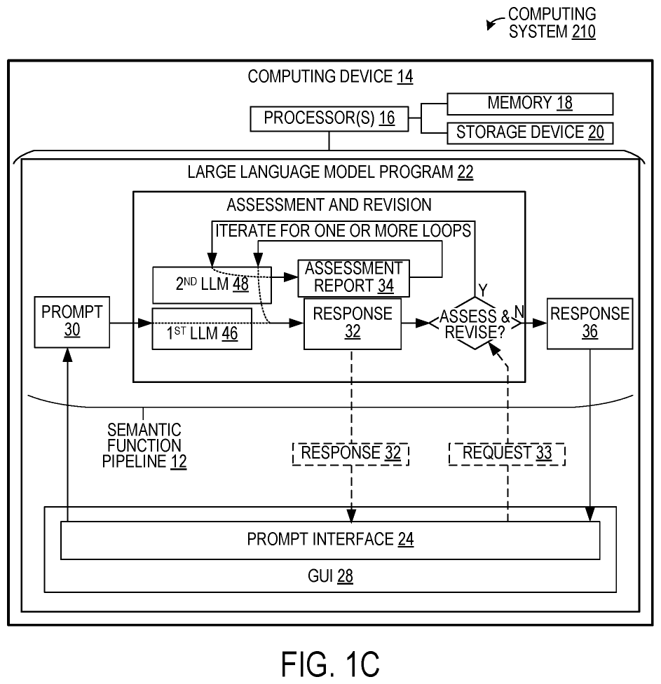

To address the issues described above, FIG. 1A illustrates a schematic view of a computing system 10 for revising large language model (LLM) input prompts using assessment and revision logic provided by a semantic function pipeline 12, according to a first example implementation. The computing system 10 includes a computing device 14 having at least one processor 16, memory 18, and storage device 20. In this first example implementation, the computing system 10 takes the form of a single computing device 14 storing an LLM program 22 in the storage device 20 that is executable by the at least one processor 16 to perform various functions including assessment and revision of the LLM input prompts according to the semantic function pipeline 12. The at least one processor 16 may be configured to cause a prompt interface 24 for a trained LLM 26 to be presented. The LLM 26 may include, for example, a generative pre-trained transformer 26A. The generative, pre-trained transformer can be a sequence-to-sequence transformer 26A including both an encoder and a decoder, which has been trained on a next word prediction task to predict a next word in a sequence. The LLM 26 may also include an embedding module 88 and image model 90 configured to generate an input vector for the LLM that includes a sequence of input tokens and associated embeddings that have been generated based on the text and image input to the model, as described below. In some instances, the prompt interface 24 may be a portion of a graphical user interface (GUI) 28 for accepting user input and presenting information to a user. In other instances, the prompt interface 24 may be presented in non-visual formats such as an audio interface for receiving and/or outputting audio, such as may be used with a digital assistant. In yet another example the prompt interface 24 may be implemented as a prompt interface application programming interface (API). In such a configuration, the input to the prompt interface may be made by an API call from a calling software program to the prompt interface API, and output can be returned in an API response from the prompt interface API to the calling software program. It will be understood that distributed processing strategies may be implemented to execute the software described herein, and the at least one processor 16 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the at least one processor 16 may be configured to execute the prompt interface API (e.g., prompt interface 24) for the trained LLM 26.

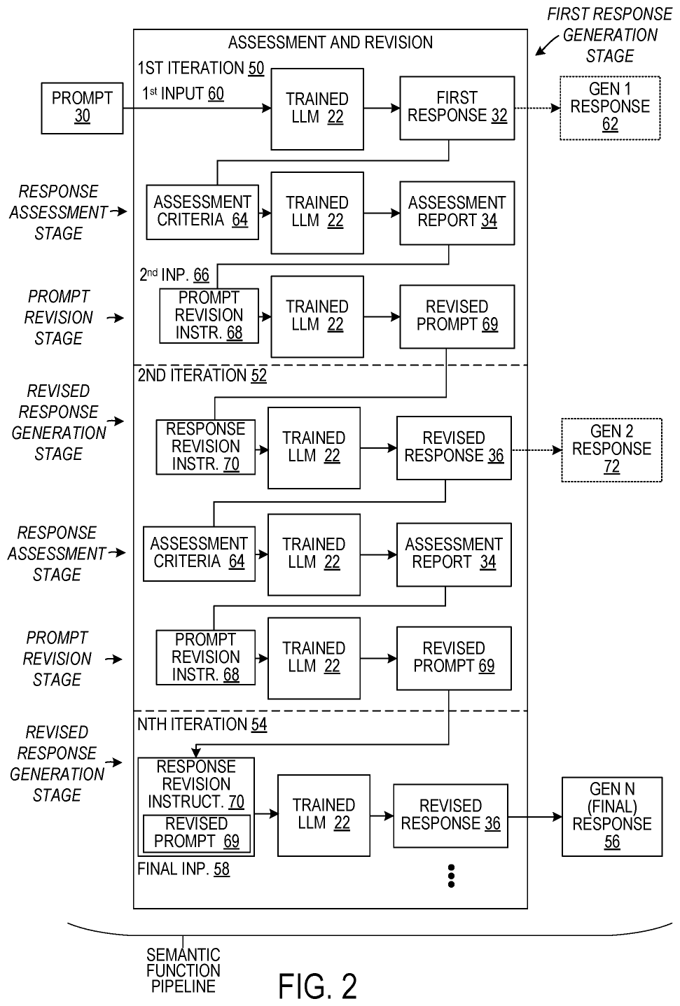

In general, the at least one processor 16 may be configured to receive, via the prompt interface 24 (in some implementations, the prompt interface API), a prompt 30 from the user including an instruction for the LLM 26 to generate an output, which will be described in more detail below with reference to FIGS. 2-5. It will be understood that the prompt may also be generated by and received from a software program, rather than directly from a human user. Briefly, the LLM 26 may be configured to receive the prompt 30 and produce a first response 32. Optionally, the first response 32 may be output to the user, who may also optionally request 33 revision if not satisfied with the first response 32. Alternatively, the LLM program 22 may be configured to self-assess and revise without further input from the user, for example, for a predetermined number of iterations. If assessment and revision is to be performed, then the LLM 26 assesses the first response 32 based on assessment criteria to thereby generate an assessment report 34, and the assessment report 34, first response 32, and prompt 30 are fed back into the LLM 26 with instructions to revise the prompt 30 in order to improve on the first response 32. If the user is not satisfied with the next response generated based on the revised prompt, if the predetermined number of iterations have not been performed, or if the assessment report 34 for the current response has not met a predefined assessment threshold, for example, then the assessment and revision is repeated for at least another iteration. However, if the current response is acceptable by either the user or predefined criteria, then the revised response 36 is output to the user.

Turning to FIG. 1B, a computing system 110 according to a second example implementation is illustrated, in which the computing system 110 includes a server computing device 38 and a client computing device 40. Here, both the server computing device 38 and the client computing device may include respective processors 16, memory 18, and storage devices 20. Description of identical components to those in FIG. 1A will not be repeated. The client computing device 40 may be configured to present the prompt interface 24 as a result of executing a client program 42 by the processor 16 of the client computing device 40. The client computing device 40 may be responsible for communicating between the user operating the client computing device 40 and the server computing device 38 which executes the LLM program 22 and contains the LLM 26, via an application programming interface (API) 44 of the LLM program 22. The client computing device 40 may take the form of a personal computer, laptop, tablet, smartphone, smart speaker, etc. The same assessment and revision process described above with reference to FIG. 1A may be performed, except in this case the prompt 30, request 33, first response 32, and revised response 36 may be communicated between the server computing device 38 and the client computing device via a network such as the Internet.

Turning to FIG. 1C, a schematic view showing a computing system 210 according to a third example implementation is illustrated. Description of similar components to those in FIGS. 1A and 1B will not be repeated, for the sake of brevity only differences will be described. Here, two LLMs are used to revise the input prompts and provide improved responses instead of just one as in FIGS. 1A and 1B. It will be appreciated that one or two LLMs may be used with either the single device implementation of FIG. 1A or the client-server implementation of FIG. 1B, and FIG. 1C merely shows the single computing device 14 by way of example.

Here, similarly to FIG. 1A, the at least one processor 16 may be configured to cause the prompt interface 24 for a first trained LLM 26 to be presented, and may receive, via the prompt interface 24, the prompt 30 from the user including an instruction for the first LLM 26 to generate an output. That is, the first LLM 26 may be the model that is responsible for generating the output for the user (e.g., responses 32 and 36) in response to a given received prompt 30. In order to efficiently utilize resources, the first LLM 46 may be a legacy model or a less computationally intensive model that requires fewer resources to run, and may be more limited in its capabilities than a second trained LLM 48. More specifically, the second LLM 26 may have a larger parameter size than the first LLM 46, meaning that there are more weights between nodes of the model, and the second LLM 48 may have a higher average computational cost to execute at inference time than the first LLM 46. The same assessment and revision described above may be performed by the second LLM 48 on the first response 32 generated by the first LLM 46 to output a revised, improved prompt that is input to the first LLM 46 to generate the next response 36. In this manner, the relatively greater capabilities of the second LLM 48 can be reserved for improving the prompt 30 which the first LLM 46 is capable of sufficiently processing to generate an acceptable response 36, without either wasting resources having the second LLM 48 perform the entire process or accepting a sub-standard output from the first LLM 46.

FIG. 2 illustrates the assessment and revision shown in FIGS. 1A-1C performed for 1 through N iterations, to thereby generate corresponding generation 1 through generation N responses. As shown, the first iteration 50 includes a first response generation stage, a response assessment stage, and a prompt revision stage, and the remaining iterations (here, second iteration 52 is shown) repeat these stages as the revised response generation stage, response assessment stage, and prompt revision stage, until the Nth iteration 54 in which a final response 56 (generation N) is output in response to a final input 58. In the first response generation stage, the at least one processor 16 is configured to provide a first input 60 including the prompt 30 to the LLM 26, and generate, in response to the first input 60, the first response 32 (which maybe output as a generation 1 response 62) to the prompt 30 via the LLM 26. The at least one processor 16 is configured to perform assessment of the response 32 and revision of the prompt 30 in the response assessment stage and prompt revision stage, at least in part by (a) assessing the first response 32 according to assessment criteria 64 to generate the assessment report 34 for the first response 32, via the LLM 26, and (b) providing second input 66 including a prompt revision instruction 68 to the LLM 26 to generate a revised prompt 69 in view of the assessment report 34. The second input 66 can include, in addition to the prompt revision instructions 68, the initial prompt 30, the first response 32, and the assessment report 34, for example. In the above process, in response to the second input 66, the at least one processor 16 executing the LLM 26 is configured to generate the revised prompt 69 via the LLM 26.

One or more intermediate iterations of these stages may be performed, as shown at the second iteration 52. As with the first iteration 50, the at least one processor 16 is configured to provide a response revision instruction 70 to the LLM 26 to generate the revised response 36 (which may be output as the generation 2 response 72) based on the revised prompt 69; assess the generated revised response 32 according to assessment criteria 64 to generate an assessment report 34 for the previously revised response 36, via the LLM 26; and provide a prompt revision instruction 68 to the LLM 26 to generate a revised prompt 69. It will be appreciated that the prompt revision instruction 68, response revision instruction 70, assessment report 34, revised prompt 69, and revised response 36 will generally all vary between iterations. In the final (Nth) iteration 54, the at least one processor 16 is configured to provide the final input 58 including the most recently generated version of the revised prompt 69 (e.g., from the second iteration 52) to the LLM 26, and, in response to the final input 58, generate the final response 56 to the revised prompt 69, via the LLM 26, and output the final response 56 to the user (in some implementations, via the prompt interface API). Should the user decide to conduct further assessment and revision after reviewing the final response 56, the user can institute the process shown in FIG. 2 once again.

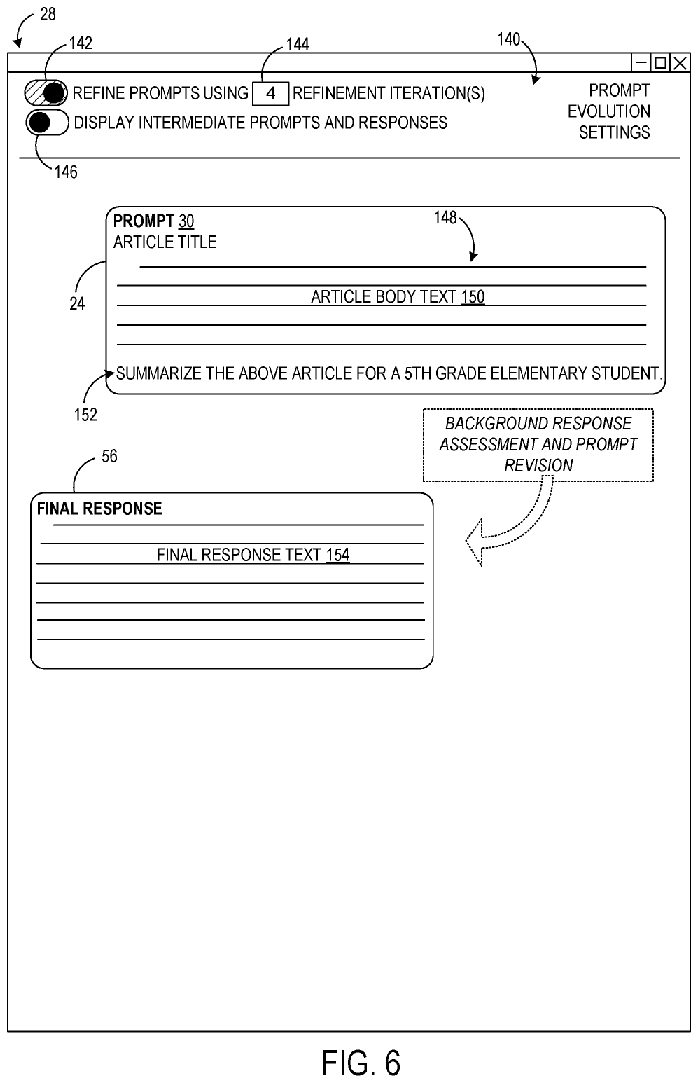

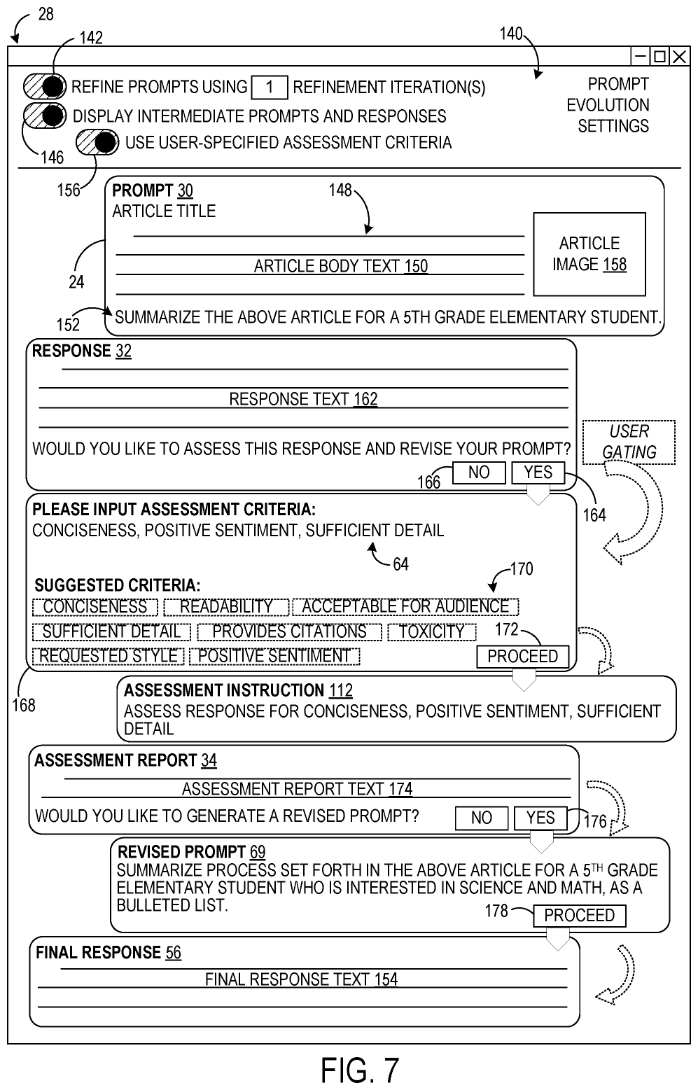

Typically, the assessment and revision of the prompt is performed iteratively for a plurality of iterations. The plurality of iterations can be a number customizable by the user, as shown in FIGS. 6 and 7 discussed below. Alternatively, the plurality of iterations can be a predefined number of iterations, such as 1, 2, 3, 4, or 5. The number of iterations could also be set programmatically or the iteration could continue until an evaluation threshold is met, such as one of the assessment criteria exceeding a certain value for a response. For example, a response might be iteratively refined for politeness assessment criteria until it met a politeness threshold, for example. Of course, to guard against waste of computational resources, a maximum number of iterations may be set, which may vary depending on the level of user (paid vs. unpaid customer, developer vs. end user, etc.). In one implementation, the at least one processor 16 is configured to output the final response 56 generated after the plurality of iterations (e.g., on a display or audibly) to the user without outputting any intermediate responses to the user, as shown in FIG. 6, discussed below. In another implementation, the intermediate responses may be presented to the user, as indicated in dashed lines for generation 1 response 62 and generation 2 response 72 in FIG. 2, and shown in FIG. 7, discussed below.

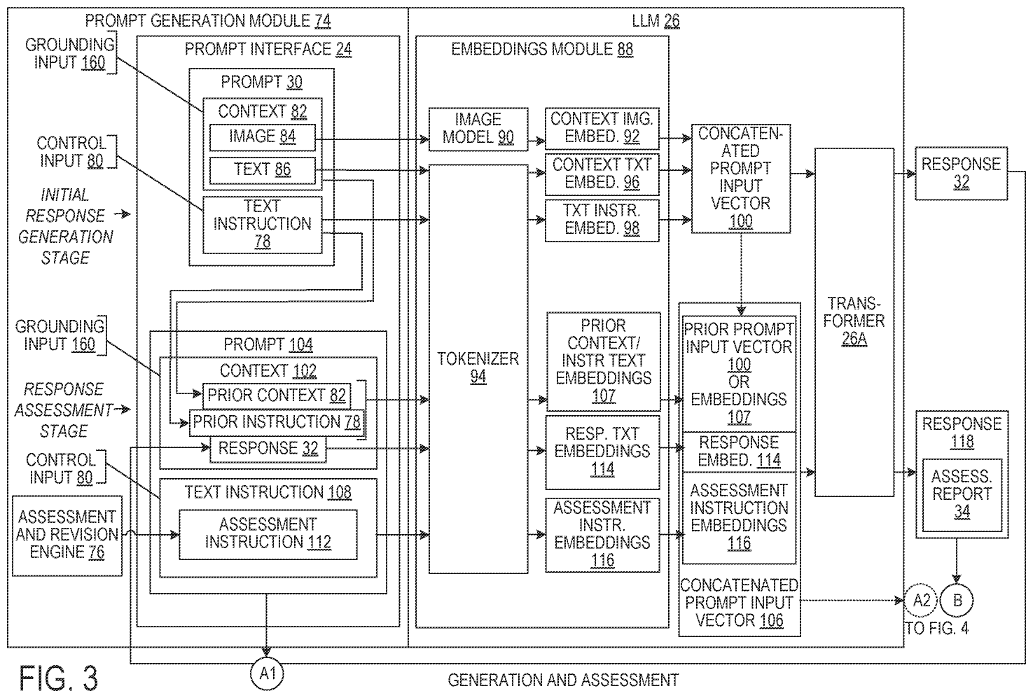

FIGS. 3-5 show in detail three respective views of the assessment and revision that is illustrated generally in FIG. 2. Turning first to FIG. 3, a prompt generation module 74 having an assessment and revision engine 76 of the LLM 26 are illustrated. The prompt generation module 74 is configured to present the prompt interface 24 that is displayed in the GUI 28, and to receive input data from the user that forms the prompt 30. The prompt 30 includes a text instruction 78 from the user, which provides control input 80 for the LLM 26. The prompt 30 also includes context input 82, which can take the form of image 84 and/or text 86, for example. Additionally or alternatively, the prompt can include audio and/or video. It will be appreciated that the LLM 26 can be multimodal, to have at least two modes of input. For example, the LLM 26 can be configured to receive a primary mode of input, such as the text mode described above, as well as one or more secondary modes of input, such as image mode, audio mode, or video mode. To achieve this, the LLM 26 may be trained on a corpus of both text and image data (and/or audio data and/or video data as appropriate), using a cross-modal encoder. One example of a multimodal input to the LLM is shown in FIG. 7 described below, which shows a prompt 30 including article text and an article image, along with textual instructions.

Next, the prompt 30 is passed to the embeddings module 88, where embeddings are computed for each of the modes of input. The embeddings module 88 is depicted as part of the LLM 26, but in an alternative implementation may be incorporated partially or fully into the prompt generation module, such that embedding representations are output from the prompt generation module to the LLM 26. An image model 90 is used to convert the context image 84 to context image embeddings 92. A tokenizer 94 is provided to convert the context text 86 to context text embeddings 96. The tokenizer 94 also produces text instruction embeddings 98 based on the text instruction 78. The context image embeddings 92, context text embeddings 96, and text instruction embeddings 98 are concatenated to form a concatenated prompt input vector 100 and are fed as the first input 60 to the LLM 26. In response to the first input 60, the LLM 26 generates the first response 32. The first response 32 is passed back to the prompt generation module 74, where it may be displayed or otherwise presented to the user, or simply held in memory for background processing. In a response assessment stage, the first response 32 is passed as context 102 into a next prompt 104. In one implementation shown in solid lines, the next prompt 104 may also include the prior context 82 and prior instruction 78 from the first response generation stage. Alternatively, to avoid re-computation of the embeddings for these data items, the concatenated prompt input vector 100 may be directly merged into a concatenated prompt input vector 106 for the response assessment stage, as shown in dashed lines.

In addition, the assessment and revision engine 76 of the prompt generation module 74 is configured to generate a text instruction 108 including an assessment instruction 112 to assess the response 32. It will be appreciated that the text instruction 108 may be user-inputted via the prompt interface 24. The response 32 and the assessment instruction 112 are each passed through the tokenizer 94 to produce respective response text embeddings 114 and assessment instruction text embeddings 116, which are in turn concatenated along with the prior prompt input vector 110 to form the concatenated prompt input vector 106 for the response assessment stage. The concatenated prompt input vector 106 for the response assessment stage is fed to the LLM 26 to thereby generate a response 118 including the assessment report 34, which can include contents such as discussed above.

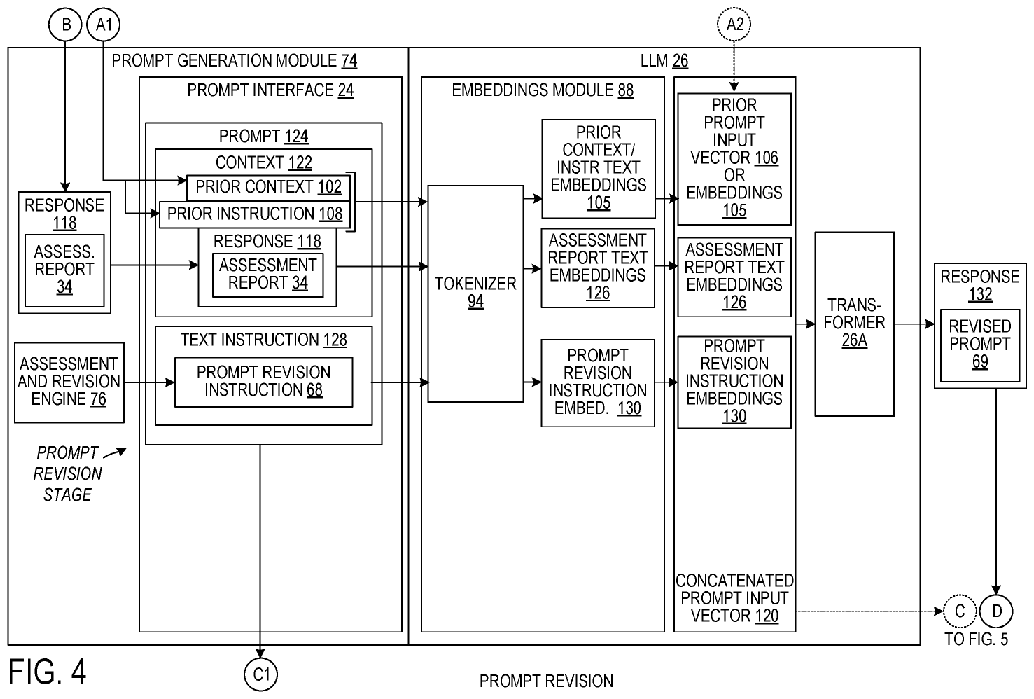

Turning now to FIG. 4, at (A1) in solid lines, the prior context 102 and prior instruction 108 can be passed as text input (or multimodal input as appropriate) into the context 122 of prompt 124, which the tokenizer converts to prior context/instruction text embeddings 105, which are incorporated into the concatenated prompt input vector 120. Alternatively, the concatenated prompt input vector 106 can be passed, as shown at (A2) in dashed lines as the prior prompt input vector 106 from the response assessment stage, to be incorporated into a concatenated prompt input vector 120 for the prompt revision stage. Further, the response 118 with the assessment report 34 is passed, as shown at (B), to be incorporated into context 122 for a prompt 124 of the prompt revision stage. The assessment report 34 is tokenized by the tokenizer 94 to produce assessment report text embeddings 126. Further, the assessment and revision engine 76 is configured to generate the prompt revision instruction 68, in the form of text instruction 128, which is passed through the tokenizer 94 of the embeddings module 88 to produce prompt revision instruction embeddings 130. It will be appreciated that the text instruction 128 may be user-inputted via the prompt interface 24. The assessment report text embeddings 126 and the prompt revision instruction embeddings 130 are concatenated with the prior prompt input vector 106 to form the concatenated prompt input vector 120 for the prompt revision stage. The concatenated prompt input vector 120 for the prompt revision stage is fed to the LLM 26 to thereby generate a response 132, including the revised prompt 69.

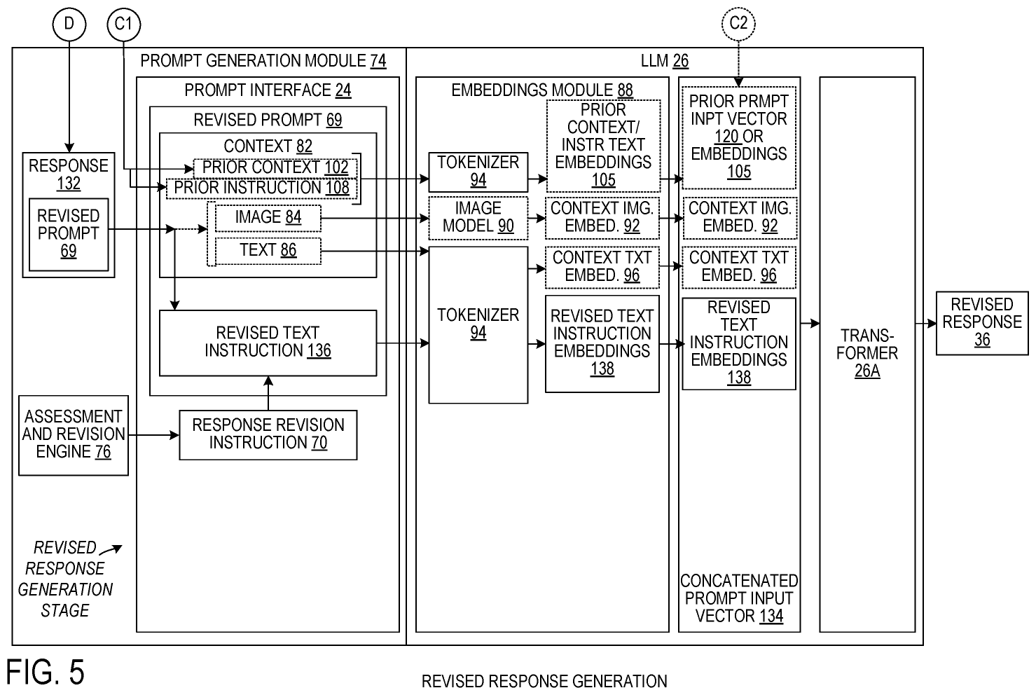

Turning now to FIG. 5, as shown at (C1) in solid lines, the prior context 102 and prior instruction 108 can be passed as text input (or multimodal input as appropriate) to the revised prompt 69 generated by the prompt generation module 74, and then tokenized by the tokenizer 94 of the LLM 26 to be included as prior context instruction text embeddings 105 in the concatenated prompt input vector 134. Alternatively, to save computational resources, the concatenated prompt input vector 120 can be passed, as shown at (C2) in dashed lines as the prior prompt input vector 120 from the prompt revision stage, to be incorporated into a concatenated prompt input vector 134 for the revised response generation stage. Further, the revised prompt 69 having revised text instructions 136 is passed, as shown at (D), to be used as the prompt of the revised response generation stage. The assessment and revision engine 76 is configured to provide the response revision instruction 70, in text form, to the revised prompt 69 in the prompt interface 24 (which may be displayed or instantiated in the background without being displayed in the GUI 28) in order instruct use of the revised text instructions 136 for generating a revised response in the revised response generation stage. It will be appreciated that the passing of the revised prompt 69 including the revised text instructions 136 may be programmatic, or the user may manually submit the revised prompt 69 in an effort to improve on the first response 32.

As shown in dashed lines, the original context 82 may be provided again by the user to be processed through the image model 90 and tokenizer 94 as in FIG. 3. Alternatively, the prior prompt input vector 120 may be directly incorporated into the concatenated prompt input vector 134 to provide the prior context 122 and prior instruction 128. The revised text instruction 136 is passed through the tokenizer 94 of the embeddings module 88 to revised text instruction embeddings 138. The revised text instruction embeddings 138 are incorporated with the prior prompt input vector 120 (optionally with the context image embeddings 92 and the context text embeddings 96) into the concatenated input vector 134 for the revised response generation stage. The concatenated input vector 134 for the revised response generation stage is fed to the LLM 26, to thereby generate the revised response 36. The assessment and revision flow shown in FIGS. 3-5 may be iterated once or a number of times, as described above, and the revised response of the final iteration (Nth iteration 54) is referred to herein as the final response 56 of the final iteration.

Turning now to FIG. 6, a first example of the GUI 28 of the computing system 10, 110, or 210 of FIGS. 1A-1C is shown. In this example, a prompt evolution settings interface 140 is provided. It will be appreciated that the least one processor 16 can be further configured to cause a prompt revision element to be displayed, and in response to user input selecting the prompt revision element, outputting the revised prompt 69 to the user. In the prompt evolution settings interface 140, a selector 142 is presented by which a user can provide user input indicating whether prompts should be refined, which serves as the prompt revision element, and can indicate using an input field 144 a user-specified number of iterations for assessment and revision, if desired. Further, a selector 146 is presented by which the user can specify whether the assessment and revision should occur in the background such that intermediate revised prompts and responses are not displayed, or whether intermediate prompts and responses should be displayed. It will be appreciated that this setting may be user configurable or may be programmatically set on the server side. In the illustrated example, the user has selected to refine prompts for 4 iterations and not display intermediate results. As shown, in the prompt interface 24 of the GUI 28, the user has entered the prompt 30 including an article 148 with article body text 150 as the context 82 and instructions 152 to “summarize the above article for a 5th grade elementary student,” and as a result, the LLM program 22 has performed four iterations of assessment and revision in the background, and outputted the final response 56 including final response text 154.

In FIG. 7, a second example of the GUI 28 is provided. In this example, the prompt evolution settings interface 140 is shown including the selector 142 by which the user has indicated that prompts are to be refined for 1 iteration. The second selector 146 is presented by which the user has indicated that intermediate prompts and responses are to be displayed, and a third selector 156 is presented by which the user has indicated that user-specified assessment criteria should be used. In the prompt interface 24 of the GUI 28 of FIG. 7, the prompt 30 inputted by the user is multimodal, including an article 148 with article body text 150 and an article image 158, as the context 82. This input will be used as grounding input 160 (see FIG. 3). The user has also inputted the same text instruction 152 which will be used by the LLM 26 as control input 80 (see FIG. 3). It will be appreciated that many LLMs are configured to utilize grounding inputs 160 and control inputs 80 during training, for example, using different attention mechanisms and/or different loss terms for each, to thereby tune the models to generate a response that is responsive to the text instruction (control input 80) and written in a style or manner that takes into account the information in the context (grounding input 160).

The dashed lines in the process flow in both FIGS. 6 and 7 show user gating, which are places where user input is requested before the prompt generation proceeds to the next stage. In response to the inputted prompt 30, the LLM 26 is configured, according to the prompt evolution settings, to display the response 32 having response text 162, along with a gating control, which asks the user “Would you like to assess this response and revise your prompt?” or similar wording. YES and NO selectors 164, 166 are displayed, by which the user can input a command to stop or proceed with revision. When the YES selector 164 is selected, the assessment and revision engine 76 of the prompt generation module 74 displays an assessment criteria text input pane 168 in which the user can input the assessment criteria 64. That is, in one implementation, the assessment criteria 64 can be received from the user. In another implementation, the assessment criteria 64 can be predetermined. For example, a set of six assessment criteria may be used including conciseness, appropriate for audience, sufficient detail, provides citations, readability, and requested style. In the illustrated example, suggested assessment criteria 170 are displayed to the user. By clicking on one of the suggested assessment criteria 170, the user can select the suggested assessment criteria 170 to be used. A proceed button 172 can be pressed for the user to cause the prompt generation module 74 to pass the assessment criteria 64 in the response assessment instruction 112 to the LLM 26, as described above in the response assessment stage. Each of the YES and PROCEED selectors discussed in relation to this example GUI 28 may serve as the prompt revision element discussed above. Next, the assessment report 34 is displayed to the user, including assessment report text 174, along with a gating control, which asks the user if the user would like to generate a revised response. The assessment report 34 may include numeric scores computed for each of the assessment criteria 64 on a scale from 1-10, as well as a natural language (textual) description of the reasons for the score for each of the assessment criteria 64, for example. In some cases, the at least one processor 16 can be further configured to request and receive information to further specify the prompt 30 from the user. This information may be requested based on the assessment report 34 and/or may be used to generate the assessment criteria 64 used in a future response assessment stage. For example, if an assessment report 34 includes a low assessment of a response 32 to an assessment criterion 64 of “acceptable for intended audience” the system can request further information from the user on the intended audience of the response 32. In addition, if the user specifies the intended audience to be college math professors, or some such similar audience, the assessment criteria can be modified to include “acceptable for audience of college math professors,” etc. The user may be able to compose freeform input, or select from preset answers, as shown in the example of the assessment criteria text input pane 168.

Upon receiving a YES selection of a YES selector 176, the prompt generation module is configured to pass the assessment report 34 and the prompt revision instruction 68 to the LLM 26 as described above in the prompt revision stage. As a result, the LLM 26 outputs the revised prompt 69, as shown. The user may be free to edit the revised prompt 69 as desired in this example, and once satisfied, the user can process a PROCEED button 178 to cause the response revision instruction 70 to instruct the revised prompt 178 to be again fed to the LLM 26, as described above in the revised response generation stage. As a result, on this final iteration of the one user-specified iteration, the final response 56 including the final response text 154 generated by the LLM 26 in response to the revised prompt 69 is displayed.

To illustrate how the assessment and revision may result in both an improved prompt and an improved final response, one example in which the article 148 mentioned above is an online article about giant pandas will be described. The first response 32 to the initial prompt 30 of “Summarize the above article for a 5th grade elementary student” may be “The article is talking about a type of bear called the giant panda. These bears live in central China and mostly eat bamboo. People are worried about the giant panda because there aren't many of them left in the wild. But some good news is that the number of pandas in the wild seems to be going up! People in China and around the world are working to keep the giant panda from becoming extinct.” The LLM 26 is then instructed to self-evaluate the previous prompt 30 (labeled PREVIOUS_PROMPT) and response 32 (labeled PREVIOUS_RESPONSE) with the following assessment instruction 112:
Complete the following survey about the PREVIOUS_PROMPT:
<AUDIENCE description=“Based on the PREVIOUS_PROMPT, who was the intended audience for this material?”>answer here</AUDIENCE>
On a scale of 1 to 10, rate the PREVIOUS_RESPONSE for each of the criteria:
<APPROPRIATENESS description=“appropriateness for the intended audience” rating=“<1-10>”/>
<READABILITY description=“How readable, understandable the PREVIOUS_RESPONSE was” rating=“<1-10>”/>
<SUCCINCTNESS description=“How well the response was summarized. Was it succinct?” rating=“<1-10>”/>
<INCLUSIVITY description=“How inclusive was the language and terminology in the PREVIOUS_RESPONSE?” rating=“<1-10>”/>
<INTERESTING description=“How interesting would the PREVIOUS_RESPONSE be to the intended audience?” rating=“<1-10>”/>.

As provided in this example, the assessment instruction 112 may include a mixture of plain language and markup. In this example, five user assessment criteria 64 are specified by the user. In response, the LLM 26 may output the following first assessment report 34, which may include one or both of a score and a written description of how well the first response 32 met the assessment criteria 64.
AUDIENCE: The intended audience seems to be 5th grade elementary school students, as specified in the prompt.
APPROPRIATENESS: 8—The response does a good job of breaking down the article into terms that elementary school students would understand, but it could be even more simplified.
READABILITY: 8—The response is generally easy to understand, but some of the vocabulary (like “extinct”) may be difficult for some 5th graders.
SUCCINCTNESS: 9—The response does a good job of summarizing the key points of the article without getting bogged down in details.
INCLUSIVITY: 10—The response uses language that is accessible for all readers.
INTERESTING: 7—The response does a good job of summarizing the article, but it could have used more exciting language to capture the attention of 5th graders.

The PREVIOUS_PROMPT and assessment report 34 are then fed back into the LLM 26 with further instructions: “Create an improved PROMPT that will yield a better result, based on these ratings.” The improved prompt 69 outputted by the LLM 26 may be “Summarize the above article for a 5th grade elementary school student, using simple vocabulary and exciting language to make it engaging for young readers.” This ends the first iteration 50 of refinement.

For the second iteration 52, the improved prompt 69 and original article 148 are inputted to the LLM 26. This time, the generation 2 response 72 may be “The article above is all about the giant panda, a bear that lives in China. The giant panda is known for its black-and-white fur and love of eating bamboo. Unfortunately, because of people destroying its habitat, the giant panda is now a vulnerable species. But the good news is that there are people working hard to help the panda, and the population is starting to grow again. The giant panda is so important to China that it's often used as a symbol for the country.” The same self-assessment instructions 112 as in the first iteration may be submitted, and the result may be as follows.
APPROPRIATENESS: 8—The response is appropriate for the intended audience, using simple vocabulary and providing a basic summary of the article. However, some of the more scientific terms (like “vulnerable species”) may need further explanation for a 5th grader.
READABILITY: 9—The response is very readable, with short sentences and simple vocabulary.
SUCCINCTNESS: 8—The response does a good job of summarizing the article in a short paragraph, although it could be even more succinct if it left out some of the less important details.
INCLUSIVITY: 10—The response does not use any language or terminology that would exclude anyone from understanding it.
INTERESTING: 8—The response is engaging and contains some interesting facts about the giant panda, but could be even more exciting if it included more sensory details or a stronger sense of urgency about the panda's plight.

After being instructed to further revise the revised prompt 69, the LLM 26 may output, “Summarize the above article for a 5th grade elementary school student, using simple vocabulary and exciting language to make it engaging for young readers. Include sensory details to make the summary more interesting, and explain any scientific terms in a way that a 5th grader would understand. Keep the summary short and concise, focusing only on the most important information.” This ends the second iteration.

Using the newest prompt 69, the LLM 26 may output the generation 3 response, “The giant panda is a big, black and white bear that only lives in China. They mostly eat bamboo, but sometimes they eat other things too. Because people have been taking over their homes, there are not many giant pandas left in the wild. Scientists are trying to help them by keeping some giant pandas in zoos. They are also trying to make more homes for the wild pandas. The giant panda is a symbol of China and was even a mascot for the 2008 Olympics.” The assessment report 34 for the third iteration may be as follows.
APPROPRIATENESS: 8—The vocabulary used was mostly appropriate for 5th grade students, but scientific terms could have been explained in a simpler way.
READABILITY: 8—The response was easy to read and understand, but could have been more engaging with exciting language and sensory details.
SUCCINCTNESS: 9—The response was well summarized and concise, focusing on the most important information.
INCLUSIVITY: 10—The language and terminology used in the response were inclusive.
INTERESTING: 7—The response was interesting, but could have been more engaging with sensory details and exciting language.

After being instructed to further revise the revised prompt 69, the LLM 26 may output, “Summarize the above scientific article for a 5th grade elementary school student, using simple and engaging language that will make it interesting for young readers. Use sensory details to help bring the summary to life, and explain any scientific terms in a way that a 5th grader would understand. Keep the summary short and concise, focusing only on the most important information. Make sure the language and terminology used are inclusive and welcoming for all students.” This ends the third iteration.

Using the newest and final revised prompt 69, the LLM 26 may output the final response 56, “The giant panda is a bear that lives in China. It has black and white fur and a round body. It mostly eats bamboo, but sometimes eats other plants or even meat. There aren't many giant pandas left in the wild because people have taken over their homes for farming and building. But people are trying to help save the pandas, and the number of pandas in the wild is going up. The giant panda is also a symbol of China and was a mascot for the Olympics.” The final response 56 may be assessed if desired, generating a score for the same categories as before of 8, 9, 10, 10, and 7. The responses across the iterations may be compared by a sum or averaged score, or another suitable comparison method may be used. In this example, the responses earned, in order, 42, 43, 42, and 44 points, showing that the final prompt 69 and response 56 improved based on the provided assessment criteria 64. By utilizing resources to improve the prompt 30 by a number of iterations before accepting a final result, the revised prompt 69 may be used for larger projects to more efficiently generate a higher quality result. For example, if a website hosting the online article about the giant panda hosted a large repository of other articles and wished to provide a summary aimed at kids for each article, before having the LLM 26 generate all of the summaries at once, it would be prudent to ensure that the prompt used globally was thoroughly tested and would generate an acceptable response, rather than relying on the expertise of the user drafting the initial prompt 30 to do well on the first try.

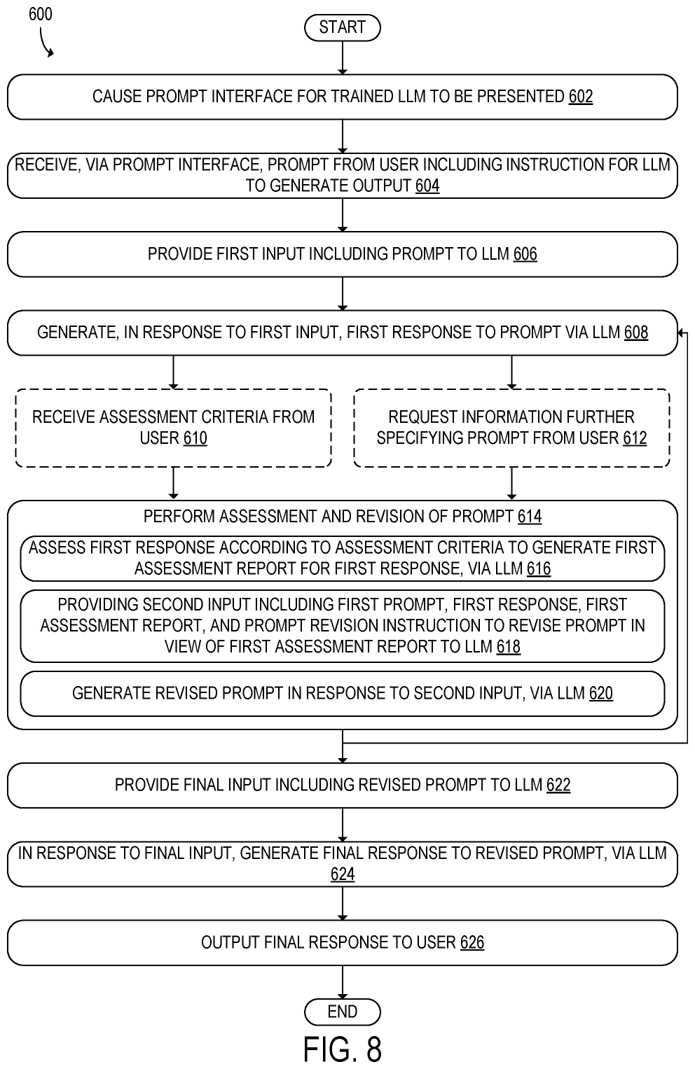

FIG. 8 shows a flowchart for a method 600 for revising LLM input prompts. The method 600 may be implemented by the computing system 10, 110, or 210 illustrated in FIGS. 1A-C.

At 602, the method 600 may include causing a prompt interface for a trained LLM to be presented. The interface may be, for example, an audio interface allowing the user to provide an audio input, or a graphical user interface (GUI) allowing the user to enter a text or graphical input. At 604, the method 600 may include receiving, via the prompt interface, a prompt from a user including an instruction for the LLM to generate an output. This prompt may be an initial prompt from the user to produce an intended output such as a text, audio, or graphical output. That is, the LLM may be multimodal. At 606, the method 600 may include providing first input including the prompt to the LLM.

At 608, the method 600 may include generating, in response to the first input, a first response to the prompt via the LLM. The first response may be acceptable to the user. However, in some cases, the user may not have written the prompt in such a way as to achieve the intended output from the LLM. The user may have been inexperienced at working with the LLM, made incorrect assumptions, or omitted helpful information. Thus, to improve the response and/or prompt, in some implementations, at 610, the method 600 may include receiving assessment criteria from the user. Alternatively, at 612, the method 600 may include requesting information further specifying the prompt from the user. That is, if the user is capable of pinpointing what the user wants out of the response, then the user may prefer to submit the assessment criteria directly, but the computing system may be capable of generating appropriate assessment criteria on behalf of the user after requesting and receiving context information such as who the intended audience of the output is. Asking the user step-by-step for further information may result in a higher quality revision even when the user is inexperienced with using LLMs. Accordingly, the assessment criteria may be generated by the LLM based on at least an intended audience of the output, the intended audience being provided by the user or inferred by the LLM. With this information, the LLM may be better able to determine if the previous response was appropriate for the intended audience, by generating relevant assessment criteria including appropriateness for the audience and then assessing the previous using the assessment criteria, as detailed below.

At 614, the method 600 may include performing assessment and revision of the prompt, at least in part by, at 616, assessing the first response according to assessment criteria to generate a first assessment report for the first response, via the LLM; at 618, providing second input including the first prompt, the first response, the first assessment report, and a prompt revision instruction to revise the prompt in view of the first assessment report to the LLM; and, at 620, generating a revised prompt in response to the second input, via the LLM. In some implementations, the assessment report may include one or both of a score and a written description of how well the first response met the assessment criteria. The score may allow for mathematical analysis and summary of how acceptable the first response is, while the written description may allow for a clear pathway for the LLM to revise the prompt in view of the assessment. It will be appreciated that the assessment may be a self-assessment by a single LLM, or else one LLM may be responsible for generating responses from prompts while another LLM is responsible for assessment of the responses and revision of the prompts. In this case, the assessing LLM may be a larger LLM having more parameters which in turn tends to require more resources to run, and may be in higher demand and/or cost more money. Using the costlier LLM to revise prompts to be run on the response generating LLM, which may be an older legacy model, allows for the responses to be generated using less resources but at a higher standard than the older LLM typically produces on its own.

In some implementations, the assessment and revision of the prompt is performed iteratively for a plurality of iterations, whereby a response to the previous prompt is assessed and the previous prompt is revised to produce an improved response. In this manner, the prompt itself is improved and both laypersons and experts can receive an improved response as a result. Furthermore, the plurality of iterations may be a number customizable by the user. This may allow the user the freedom to decide whether to invest more or less resources into improving the prompt based on the user's needs and available resources.

At 622, the method 600 may include providing final input including the revised prompt to the LLM. That is, the final input may be the last input after all iterations are run, in the case where the prompt is iteratively revised. At 624, the method 600 may include, in response to the final input, generating a final response to the revised prompt, via the LLM. At 626, the method 600 may include outputting the final response to the user. In this manner, the user may receive the final response that meets the assessment criteria where the first response may have failed or scored lower, and is therefore more likely to be deemed acceptable by the user. In some implementations, the final response generated after the plurality of iterations may be output to the user without outputting any intermediate responses to the user. Accordingly, the system may be able to present a best impression to the user of being highly capable and immediately generating precisely what the user wanted.

The systems and methods described above offer the potential technical advantage of reducing computational resources during generation of LLM responses, while increasing their utility and effectiveness for users. For example, the systems and method described above can reduce the number of times users repeatedly prompt the LLM in trial and error attempts to extract useful information, by more quickly and efficiently refining the user prompt. One class of users for whom this applies are developers who are developing software that utilizes LLMs. These developers can configure the system above by providing a test data set that can be input as context against which the response from the LLM will be assessed when using the software. In this way, the developer can provide assessment criteria by which prompt responses can be evaluated, thus assisting the system to more effectively generate responses to user prompts. Another class of users for whom the systems and methods described above offer technical advantages are end users. The systems and methods provided above can be configured to programmatically and dynamically revise prompts entered by the user, to assess the LLMs responses in view of assessment criteria that meets the user's needs, and evolve those prompts to improve the responses in view of the assessment criteria, to thereby better the user's expectations. This helps save computational resources as it decreases the trial and error cycles of the user searching for prompts that might elicit useful responses from the LLM. In some implementations, it can also enable a lower resourced and less computationally expensive LLM to respond to a user prompt with a level of responsiveness that meets or exceeds a larger, more expensive model, thereby saving computational resources.

In some embodiments, the methods and processes described herein may be tied to a computing system of one or more computing devices. In particular, such methods and processes may be implemented as a computer-application program or service, an application-programming interface (API), a library, and/or other computer-program product.

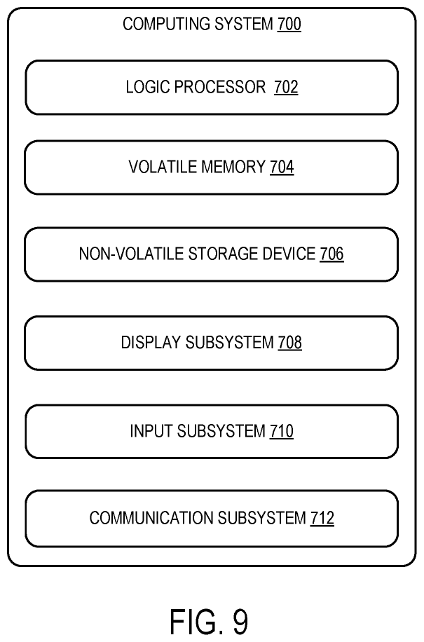

FIG. 9 schematically shows a non-limiting embodiment of a computing system 700 that can enact one or more of the methods and processes described above. Computing system 700 is shown in simplified form. Computing system 700 may embody the computing system 10, 110, 210 described above and illustrated in FIGS. 1A-1C. Computing system 700 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 9.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

The following paragraphs provide additional support for the claims of the subject application. One aspect provides a computing system for revising large language model (LLM) input prompts. The computing system comprises at least one processor configured to cause a prompt interface for a trained LLM to be presented, receive, via the prompt interface, a prompt from a user including an instruction for the LLM to generate an output, provide first input including the prompt to the LLM, and generate, in response to the first input, a first response to the prompt via the LLM. The at least one processor is configured to perform assessment and revision of the prompt, at least in part by assessing the first response according to assessment criteria to generate an assessment report for the first response, via the LLM, providing second input including the first prompt, the first response, the assessment report, and a prompt revision instruction to revise the prompt in view of the first assessment report to the LLM, and generating a revised prompt in response to the second input, via the LLM. The at least one processor is configured to provide final input including the revised prompt to the LLM, in response to the final input, generate a final response to the revised prompt, via the LLM, and output the final response to the user. In this aspect, additionally or alternatively, the assessment and revision of the prompt may be performed iteratively for a plurality of iterations. In this aspect, additionally or alternatively, the plurality of iterations may be a number customizable by the user. In this aspect, additionally or alternatively, the at least one processor may be further configured to output the final response generated after the plurality of iterations to the user without outputting any intermediate responses to the user. In this aspect, additionally or alternatively, the LLM may be multimodal. In this aspect, additionally or alternatively, the assessment criteria may be received from the user. In this aspect, additionally or alternatively, the at least one processor may be further configured to request information further specifying the prompt from the user. In this aspect, additionally or alternatively, the assessment criteria may be generated by the LLM based on at least an intended audience of the output, the intended audience being provided by the user or inferred by the LLM. In this aspect, additionally or alternatively, the assessment report may include one or both of a score and a written description of how well the first response met the assessment criteria. In this aspect, additionally or alternatively, the at least one processor may be further configured to cause a prompt revision element to be displayed, and in response to user input selecting the prompt revision element, outputting the revised prompt to the user.

Another aspect provides a method for revising large language model (LLM) input prompts. The method comprises causing a prompt interface for a trained LLM to be presented, receiving, via the prompt interface, a prompt from a user including an instruction for the LLM to generate an output, providing first input including the prompt to the LLM, generating, in response to the first input, a first response to the prompt via the LLM, and performing assessment and revision of the prompt, at least in part by assessing the first response according to assessment criteria to generate an assessment report for the first response, via the LLM, providing second input including the first prompt, the first response, the assessment report, and a prompt revision instruction to revise the prompt in view of the assessment report to the LLM, and generating a revised prompt in response to the second input, via the LLM. The method further comprises providing final input including the revised prompt to the LLM, in response to the final input, generating a final response to the revised prompt, via the LLM, and outputting the final response to the user. In this aspect, additionally or alternatively, the assessment and revision of the prompt may be performed iteratively for a plurality of iterations. In this aspect, additionally or alternatively, the plurality of iterations may be a number customizable by the user. In this aspect, additionally or alternatively, the final response generated after the plurality of iterations may be output to the user without outputting any intermediate responses to the user. In this aspect, additionally or alternatively, the LLM is multimodal. In this aspect, additionally or alternatively, the method may further comprise receiving the assessment criteria from the user. In this aspect, additionally or alternatively, the method may further comprise requesting information further specifying the prompt from the user. In this aspect, additionally or alternatively, the assessment criteria may be generated by the LLM based on at least an intended audience of the output, the intended audience being provided by the user or inferred by the LLM. In this aspect, additionally or alternatively, the assessment report may include one or both of a score and a written description of how well the first response met the assessment criteria.

Another aspect provides a computing system for revising large language model (LLM) input prompts. The computing system comprises at least one processor configured to cause a prompt interface for a first trained LLM to be presented, receive, via the prompt interface, a prompt from a user including an instruction for the first LLM to generate an output, provide first input including the prompt to the first LLM, generate, in response to the first input, a first response to the prompt via the first LLM, perform assessment and revision of the prompt, at least in part by assessing the first response according to assessment criteria to generate an assessment report for the first response, via a second LLM, the second LLM having a larger parameter size than the first LLM, providing second input including the first prompt, the first response, the assessment report, and a prompt revision instruction to revise the prompt in view of the assessment report to the second LLM, and generating a revised prompt in response to the second input, via the second LLM, provide final input including the revised prompt to the first LLM, in response to the final input, generate a final response to the revised prompt, via the first LLM, and output the final response to the user.

Another aspect provides a computing system for revising large language model (LLM) input prompts. The computing system comprises at least one processor configured to execute a prompt interface application programming interface (API) for a trained LLM, receive, via the prompt interface API, a prompt including an instruction for the LLM to generate an output, provide first input including the prompt to the LLM, generate, in response to the first input, a first response to the prompt via the LLM, perform assessment and revision of the prompt, at least in part by assessing the first response according to assessment criteria to generate an assessment report for the first response, via the LLM, providing second input including the first prompt, the first response, the assessment report, and a prompt revision instruction to revise the prompt in view of the first assessment report to the LLM, and generating a revised prompt in response to the second input, via the LLM, provide final input including the revised prompt to the LLM, in response to the final input, generate a final response to the revised prompt, via the LLM, and output the final response via the prompt interface API.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for revising large language model (LLM) input prompts, the computing system comprising:
at least one processor configured to:
cause a prompt interface for a trained LLM to be presented;
receive, via the prompt interface, a prompt from a user including an instruction for the LLM to generate an output;
provide first input including the prompt to the LLM;
generate, in response to the first input, a first response to the prompt via the LLM;
perform assessment and revision of the prompt, at least in part by:
assessing the first response according to assessment criteria to generate an assessment report for the first response, via the LLM;
providing second input including the first prompt, the first response, the assessment report, and a prompt revision instruction to revise the prompt in view of the first assessment report to the LLM; and
generating a revised prompt in response to the second input, via the LLM;
provide final input including the revised prompt to the LLM;
in response to the final input, generate a final response to the revised prompt, via the LLM; and
output the final response to the user.

2. The computing system of claim 1, wherein the assessment and revision of the prompt is performed iteratively for a plurality of iterations.

3. The computing system of claim 2, wherein the plurality of iterations is a number customizable by the user.

4. The computing system of claim 2, wherein the at least one processor is further configured to output the final response generated after the plurality of iterations to the user without outputting any intermediate responses to the user.

5. The computing system of claim 1, wherein the LLM is multimodal.

6. The computing system of claim 1, wherein the assessment criteria are received from the user.

7. The computing system of claim 1, wherein the at least one processor is further configured to request information further specifying the prompt from the user.

8. The computing system of claim 1, wherein the assessment criteria are generated by the LLM based on at least an intended audience of the output, the intended audience being provided by the user or inferred by the LLM.

9. The computing system of claim 1, wherein the assessment report includes one or both of a score and a written description of how well the first response met the assessment criteria.

10. The computing system of claim 1, wherein the at least one processor is further configured to:
cause a prompt revision element to be displayed; and
in response to user input selecting the prompt revision element, outputting the revised prompt to the user.

11. A method for revising large language model (LLM) input prompts, the method comprising:
causing a prompt interface for a trained LLM to be presented;
receiving, via the prompt interface, a prompt from a user including an instruction for the LLM to generate an output;
providing first input including the prompt to the LLM;
generating, in response to the first input, a first response to the prompt via the LLM;
performing assessment and revision of the prompt, at least in part by:
assessing the first response according to assessment criteria to generate an assessment report for the first response, via the LLM;
providing second input including the first prompt, the first response, the assessment report, and a prompt revision instruction to revise the prompt in view of the assessment report to the LLM; and
generating a revised prompt in response to the second input, via the LLM;
providing final input including the revised prompt to the LLM;
in response to the final input, generating a final response to the revised prompt, via the LLM; and
outputting the final response to the user.

12. The method of claim 11, wherein the assessment and revision of the prompt is performed iteratively for a plurality of iterations.

13. The method of claim 12, wherein the plurality of iterations is a number customizable by the user.

14. The method of claim 12, wherein the final response generated after the plurality of iterations is output to the user without outputting any intermediate responses to the user.

15. The method of claim 11, wherein the LLM is multimodal.

16. The method of claim 11, further comprising receiving the assessment criteria from the user.

17. The method of claim 11, further comprising requesting information further specifying the prompt from the user.

18. The method of claim 11, wherein the assessment criteria are generated by the LLM based on at least an intended audience of the output, the intended audience being provided by the user or inferred by the LLM.

19. The method of claim 11, wherein the assessment report includes one or both of a score and a written description of how well the first response met the assessment criteria.

20. A computing system for revising large language model (LLM) input prompts, the computing system comprising:
at least one processor configured to:
execute a prompt interface application programming interface (API) for a trained LLM;
receive, via the prompt interface API, a prompt including an instruction for the LLM to generate an output;
provide first input including the prompt to the LLM;
generate, in response to the first input, a first response to the prompt via the LLM;
perform assessment and revision of the prompt, at least in part by:
assessing the first response according to assessment criteria to generate an assessment report for the first response, via the LLM;
providing second input including the first prompt, the first response, the assessment report, and a prompt revision instruction to revise the prompt in view of the first assessment report to the LLM; and
generating a revised prompt in response to the second input, via the LLM;
provide final input including the revised prompt to the LLM;
in response to the final input, generate a final response to the revised prompt, via the LLM; and
output the final response via the prompt interface API.
